(19) United States
(12) Patent Application Publication
(10) Pub. No.: US 2019/0265690 A1
(43) Pub. Date: Aug. 29, 2019

(54) SYSTEM AND METHOD FOR A FAILSAFE SYSTEM FOR AUTONOMOUS VEHICLES

(71) Applicant: Walmart Apollo, LLC, Bentonville, AR (US)

(72) Inventors: Todd MATTINGLY, Bentonville, AR (US); Robert CANTRELL, Herndon, VA (US); John J. O'BRIEN, Farmington, AR (US); Justin SCHUHARDT, Montara, CA (US); Brian MCHALE, Oldham (GB)

(73) Assignee: Walmart Apollo, LLC, Bentonville, AR (US)

(21) Appl. No.: 16/287,084

(22) Filed: Feb. 27, 2019

Related U.S. Application Data
(60) Provisional application No. 62/636,742, filed on Feb. 28, 2018.

(51) Int. Cl. G05D 1/00; B64C 39/02; G05D 1/10; G08G 5/00; H04W 4/40; H04L 9/06; H04L 9/32

(52) U.S. Cl. CPC G05D 1/0022; B64C 39/024; G05D 1/0088; G05D 1/101; G08G 5/0039; G08G 5/0069; H04L 2209/38; H04L 9/0637; H04L 9/3236; B64C 2201/141; B64C 2201/146; B64C 2201/126; B64C 2201/128; H04W 4/40

(57) ABSTRACT

Systems, methods, and computer-readable storage media for iteratively planning autonomous vehicle missions with additional security. A system configured as disclosed herein generates a preliminary mission profile and a preliminary route for executing the mission. This information is transmitted to multiple third parties which can provide real-time updates regarding the proposed plan, and the system can iteratively update the proposed plan. In addition, the system can receive preliminary approval of the mission from regulatory bodies. Upon finalizing the plan, the system can receive an updated, final approval from the regulatory body, then store the mission and the mission-formation history in a blockchain on the autonomous vehicle. This blockchain can then be used for the execution of the mission.

### PRIORITY

The present application claims priority to U.S. Provisional Application No. 62/636,742, filed Feb. 28, 2018, the contents of which are incorporated herein in their entirety.

### BACKGROUND

### 1. Technical Field

The present disclosure relates to mission planning for autonomous vehicles, and more specifically to iteratively modifying aspects of the mission based on third party information.

### 2. Introduction

The use of autonomous vehicles continues to increase, such that autonomous vehicles are being used for everything from transporting people to delivering packages. However, there are many concerns over the ability for these autonomous vehicles to be hacked, taken control of, or illegally operated. For instance, drones which operate based on line-of-sight communications with an antenna or satellite, could have those communications interrupted by a nefarious third party which then takes possession of the drone and/or modifies the drone mission. If the drone were delivering a package, this could result in the package being dropped off in the wrong location.

### SUMMARY

An exemplary method which can be performed according to the concepts disclosed herein can include: receiving a mission profile for an autonomous vehicle, the mission profile comprising: a start location; a second location; and an action to perform at the second location; generating a preliminary route between the start location and the second location; transmitting the mission profile and the preliminary route to a plurality of third parties; receiving, from each party in the plurality of third parties, a response providing either (1) an approval of the mission profile and the preliminary route or (2) a modification to at least one of the mission profile and the preliminary route, to yield a plurality of preliminary responses; modifying at least one of the mission profile and preliminary route based on the plurality of preliminary responses, to yield second iteration mission information; identifying, using current status information of a plurality of autonomous vehicles, a specific autonomous vehicle capable of performing a mission according to the second iteration mission information; revising the second iteration mission information based on the specific autonomous vehicle, to yield third iteration mission information; transmitting the third iteration mission information to a final approval authority from the plurality of third parties; and receiving a mission decision from the final approval authority.

An exemplary system which can be configured according to this disclosure can include: a processor; and a computer-readable storage medium having instructions stored which, when executed by the processor, cause the processor to perform operations comprising: receiving a mission profile for an autonomous vehicle, the mission profile comprising: a start location; a second location; and an action to perform at the second location; generating a preliminary route between the start location and the second location; transmitting the mission profile and the preliminary route to a plurality of third parties; receiving, from each party in the plurality of third parties, a response providing either (1) an approval of the mission profile and the preliminary route or (2) a modification to at least one of the mission profile and the preliminary route, to yield a plurality of preliminary responses; modifying at least one of the mission profile and preliminary route based on the plurality of preliminary responses, to yield second iteration mission information; identifying, using current status information of a plurality of autonomous vehicles, a specific autonomous vehicle capable of performing a mission according to the second iteration mission information; revising the second iteration mission information based on the specific autonomous vehicle, to yield third iteration mission information; transmitting the third iteration mission information to a final approval authority from the plurality of third parties; and receiving a mission decision from the final approval authority.

An exemplary non-transitory computer-readable storage device which can be configured according to this disclosure can store instructions which, when executed by a computing device, can perform operations including: receiving a mission profile for an autonomous vehicle, the mission profile comprising: a start location; a second location; and an action to perform at the second location; generating a preliminary route between the start location and the second location; transmitting the mission profile and the preliminary route to a plurality of third parties; receiving, from each party in the plurality of third parties, a response providing either (1) an approval of the mission profile and the preliminary route or (2) a modification to at least one of the mission profile and the preliminary route, to yield a plurality of preliminary responses; modifying at least one of the mission profile and preliminary route based on the plurality of preliminary responses, to yield second iteration mission information; identifying, using current status information of a plurality of autonomous vehicles, a specific autonomous vehicle capable of performing a mission according to the second iteration mission information; revising the second iteration mission information based on the specific autonomous vehicle, to yield third iteration mission information; transmitting the third iteration mission information to a final approval authority from the plurality of third parties; and receiving a mission decision from the final approval authority.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example of a preliminary route;

FIG. 2 illustrates an example of contacting third parties;

FIG. 3 illustrates an example of a revised route;

FIG. 4 illustrates an exemplary flow chart for an aircraft mission;

FIG. 5 illustrates an example method embodiment; and

FIG. 6 illustrates an exemplary computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

Autonomous vehicles configured according to this disclosure can have a higher security (meaning difficult to access and/or manipulate) of the mission data saved on the autonomous vehicle due to the manner in which the data can be saved. In addition, the accuracy of the mission assigned to the autonomous vehicle can be higher due to the parallel, iterative process of mission planning. That same parallel, iterative mission planning process can result in faster, more accurate transmission and reception of required data.

Consider the following example. As an assignment is received for a drone-based delivery, the computing system (such as a server) which assigns drones to perform deliveries can first make several determinations. It can, for example, plan the route required for the delivery (e.g., from the distribution center to the customer's home) by navigating around obstacles, weather, no-fly zones, etc. While some information, such as road maps and geographic obstacles, may be constant, many of the other factors may vary from minute to minute. Moreover, the type of drone which can perform the mission may vary based on those variable factors.

To account for the variable factors, the computing system can first plan a preliminary route for the drone to follow from the distribution center (or other starting location) to the second location (such as the customer's house), with the drone performing an action such as a delivery, pickup, taking a photograph, etc., at the second location. The preliminary route can be, for example, the fastest path between the start location and the second location according to known variables. This preliminary mission data (i.e., the start location, end location, and action to be performed) along with the preliminary route can then be transmitted to various third parties for (1) additional information about the proposed route which may require altering the route, and/or (2) a preliminary approval of the overall mission.

In some configurations, the third parties contacted can vary based on the time of day, the type of package being delivered, the planned route, the start/end locations, etc. Indeed, the third parties contacted can vary from iteration to iteration, due to changing details or aspects of the plan.

Transmission to the third parties can occur in parallel. That is, the computing system can transmit the preliminary mission data and/or the preliminary route to a weather service, a traffic service, and an approving agency in parallel. In some cases, such as a weather service and the traffic service, the data provided by the weather service can be based on current and predicted values. That is, the data provided by the weather service could be for current weather conditions along the proposed route, and/or for future weather conditions at a proposed time of the mission. Approving agencies may provide a preliminary approval of the mission based on the preliminary mission data and the preliminary route information. Alternatively, the approving agencies may provide information instructing the system to re-route the drone a different way to avoid other drones, planes, no-fly zones, etc. In addition to providing data about the proposed route, in some cases, the third parties may require an additional waypoint be added to the route, and/or that the type of action to be undertaken by the drone be modified.

As the data is received from the various entities, the computing system can modify the preliminary route and/or action. This iterative process, of transmitting proposed plans to third parties, then modifying the mission data/route based on the responses received from the third parties, can occur many times. For simplicity, the examples provided herein use only a single iteration.

With the mission data/route modified, the system can seek to identify which specific drone will perform the mission. This can be based on, for example, the ability of the drones to complete the required task (i.e., travel the required distance and perform the required action), availability of the drones, regulations associated with the drones, etc. The system accesses a database having access to current and/or future drone availability, from which the system can select the drone best capable of performing the updated mission.

With the drone selected and the mission updated, the system can transmit the updated mission data and/or updated route to a final approval authority. For example, the final approval authority can be, for example, a government agency which approves the updated mission/route. The final approval authority can then transmit an approval or rejection back to the system. Alternatively, the final approval authority can provide additional information which can be used to further modify the mission data and/or route. The iterative process can then repeat until the final approval authority approves the mission. In some circumstances, there may not be a final approval authority, in which cases the system can determine that the mission reaches a sufficient level of verification and planning, and can self-approve the mission.

As the instructions to perform the mission are first received, the system can generate a mission-specific blockchain. The blockchain can use asymmetrical encryption, such that without a known key the data contained within the blockchain cannot be viewed. In some configurations, the mission-specific blockchain can only be stored and updated by the system (that is, the blockchain is not distributed among multiple nodes, and other nodes lack permission to read or write to the blockchain). In such configurations, the system can transmit mission information to the third parties, receive responses from the third parties, and store the received third-party information in new blocks which are added to the blockchain. In other configurations, the block of the blockchain containing the latest iteration of the mission plan can be transmitted to the third parties. The third parties can then have the necessary key to read the data stored within the block. In yet other cases, the third parties can each receive the entirety of the blockchain.

The third parties can transmit unencrypted/non-blocked data back to the system. The system, upon receiving the information, can then generate a new block containing the received information and add that new block to the blockchain. In other configurations, the third parties can generate a new block which is transmitted to the system, the new block containing the third party's response to the preliminary mission data.

Upon receiving approval of the mission from the final approval authority, the system can copy the blockchain to the selected autonomous vehicle. The autonomous vehicle can then use the data contained within the blockchain to execute the mission. As the mission is executed, the autonomous vehicle can add information to the blockchain, and as the mission is completed, the blockchain record of the mission (how the mission was formed, approved, and executed) can be saved to a database connected to the system.

During the iterative process of transmitting data to the third parties and receiving updates and/or approval, the data transmitted from the system to the third parties can be reduced to only the changes from data previously sent to any given third party. For example, if preliminary data is sent to a third party which also happens to be the final approval authority, after responses from the third party are received the mission data can be updated, then only the changes between the updated mission data and the preliminary mission data can be transmitted to the final approval authority. Likewise, if multiple iterations of the path are required, each iteration can include the system re-transmitting only changes to the data to the necessary third parties. In this manner, the bandwidth required to be transmitted can be reduced from the full amount of data being considered.

In configurations where the mission data and route are saved to a blockchain, updating or modifying the blockchain once the mission data is saved to the autonomous vehicle can be inhibited through the use of private/public keys (a form of asymmetrical encryption). For example, the autonomous vehicle may have a public key which allows it to decipher the data stored within the blockchain and make navigation decisions based on that data. However, the autonomous vehicle may lack a private key necessary to obtain permission to write to the blockchain. In such a configuration, only the master system which planned the route (and communicated with the various third parties) would have the private key/be permissioned to write to the blockchain. This can mitigate the ability for others to hack or otherwise take control of the autonomous vehicle, because in order to upload new instructions to the autonomous vehicle the potential pirate would need to have not only the communications capability to communicate with the autonomous vehicle, but also the correct key for uploading new instructions to the autonomous vehicle's blockchain.

After a mission, the autonomous vehicle data recorded during the mission can be imported into a block, then added to the blockchain. This “final” version of the blockchain can then be deleted from the autonomous vehicle and saved on a database in communication with the system. Such a configuration can preserve the full record of how the mission was planned, authorized, and executed, while not taking up additional data storage on the autonomous vehicle.

In some configurations, the selection of an autonomous vehicle can be performed using a bidding system by autonomous vehicle operators. For example, if a user is requesting a driverless vehicle to transport the user across town, the request can be submitted and multiple driverless vehicles can bid for the opportunity to perform the task.

Having provided general examples, the disclosure now turns to the specific examples provided in the figures. Aspects of the specific examples can be combined, added, or removed, based on the specific needs of a given configuration.

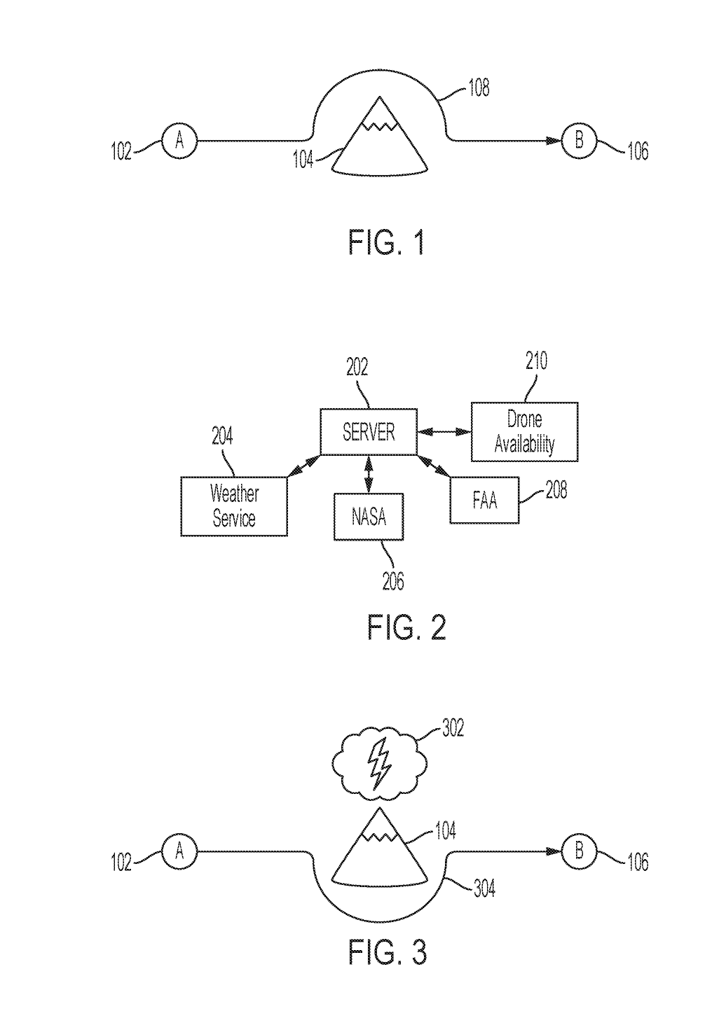

FIG. 1 illustrates an example of a preliminary route 108. The system has received instructions indicating that an autonomous vehicle needs to travel from point A 102 to point B 106. The system generates a preliminary route 108 using stored map information which notes that there is a mountain 104 between A 102 and B 106. Based on the map information, the preliminary route 108 has a curve around the mountain 104.

After generating the preliminary route, the system contacts third party databases. FIG. 2 illustrates an example of contacting third party databases 204, 206, 208, 210. The system 202, in this case a server or other computing device, has generated the preliminary route and transmits the preliminary route with any necessary mission data to one or more of the third parties. The information transmitted to each respective third party can vary based on the type of data or evaluation the third party can provide. For example, when pinging a weather service, the type of mission being performed is unlikely to vary the data or response the weather service would provide, so additional mission data (other than the preliminary route) may not be required. However, when providing initial data to a government agency, such as the FAA, data about the route as well as the type of mission being conducted (such as cargo type, speed, altitude, etc.) may be required.

The system 202 receives responses back from the third parties 204, 206, 208, 210, and revises the route and/or mission accordingly. FIG. 3 illustrates an example of a revised route 304. In this case, the mission still requires an autonomous vehicle to travel between points A 102 and B 106 while avoiding the mountain 104, however based on data received from a weather service the system is now informed of a thunderstorm 302 on one side of the mountain 104. The system has therefore modified the route 304 to avoid both the mountain 104 and the thunderstorm 302.

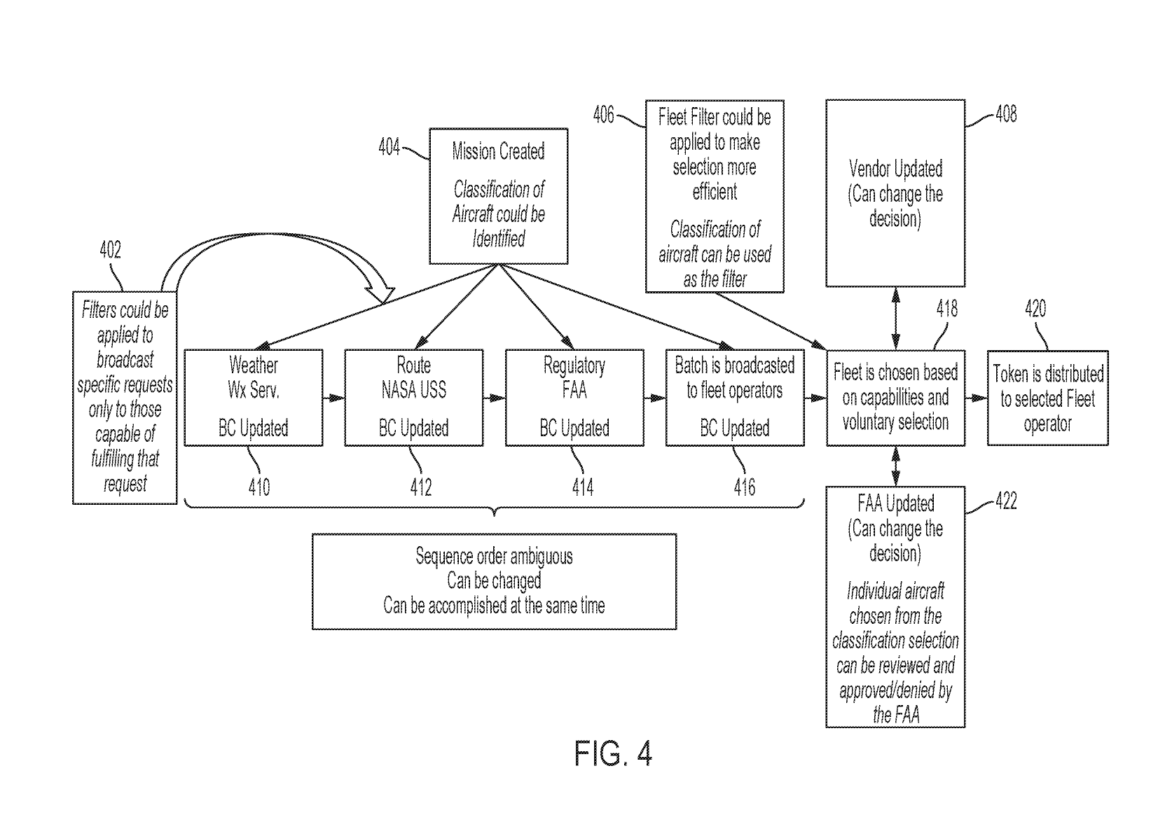

FIG. 4 illustrates an exemplary flow chart for an aircraft mission. In this example, a mission is created 404 which requires use of an aircraft. Preliminary mission data and a preliminary route can be generated, then forwarded to third parties such as a weather service 410, NASA 412, the FAA 414, and/or fleet operators 416. To determine to which third parties the data is transmitted, filters can be applied such that only those capable of fulfilling a request receive the data 402. In some configurations, the third parties can be contacted sequentially, whereas in other configurations the third parties can be contacted in parallel. In addition, the responses/information received from each third party can be used to update a history of the mission creation process. For example, this mission history can be captured in a blockchain or other encrypted database.

After the third parties 410, 412, 414, 416 have provided responses and the mission has been updated, an autonomous vehicle can be selected based on capabilities and voluntary selection 418. A filter 406 can be applied to improve the speed and/or accuracy of the autonomous vehicle selection process 418. Based on the selection process, the vendor (or other ultimate decision making authority over the mission) can modify the autonomous vehicle selection 408. Once an autonomous vehicle is selected, the FAA (or other regulatory body) can be updated 422 with the final mission plan and route. If the FAA requires changes to the plan/route, further iterations can occur. If the FAA approves the plan, a token (or the blockchain) can be provided to the autonomous vehicle selected to perform the mission, which the autonomous vehicle can then use to execute the mission.

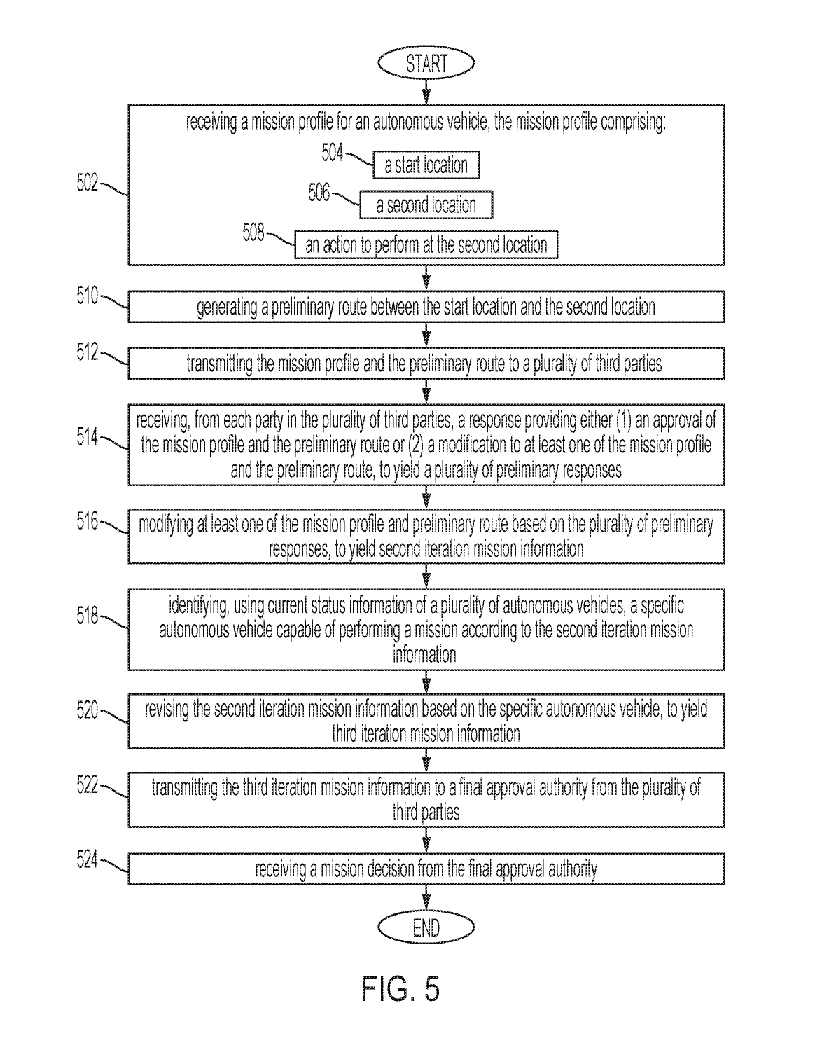

FIG. 5 illustrates an example method embodiment. The steps outlined herein are exemplary and can be implemented in any combination thereof, including combinations that exclude, add, or modify certain steps. In this example, the system receives a mission profile for an autonomous vehicle, the mission profile (502) comprising: a start location (504); a second location (506); and an action to perform at the second location (508).

The system then generates a preliminary route between the start location and the second location (510) and transmits the mission profile and the preliminary route to a plurality of third parties (512). The system then receives, from each party in the plurality of third parties, a response providing either (1) an approval of the mission profile and the preliminary route or (2) a modification to at least one of the mission profile and the preliminary route, to yield a plurality of preliminary responses (514).

The system modifies at least one of the mission profile and preliminary route based on the plurality of preliminary responses, to yield second iteration mission information (516) and identifies, using current status information of a plurality of autonomous vehicles, a specific autonomous vehicle capable of performing a mission according to the second iteration mission information (518). The system also revises the second iteration mission information based on the specific autonomous vehicle, to yield third iteration mission information (520). The system transmits the third iteration mission information to a final approval authority from the plurality of third parties (522) and receiving a mission decision from the final approval authority (524).

In some configurations, this method can be augmented to further include generating a blockchain using the mission profile, the preliminary route, the plurality of preliminary responses, the second iteration mission information, the third iteration mission information, and the mission decision. In such configurations, a copy of the blockchain can be stored on the specific autonomous vehicle when travelling between the start location and the second location and while executing the action. The blocks within the blockchain can contain specific data regarding the iterations, mission data, etc. For example, a first block of the blockchain can contain the mission profile; a second block or blocks can contain the preliminary response or responses in the plurality of preliminary responses; a third block can contain second iteration mission information; a fourth block can contain third iteration mission information; and a fifth block can contain the mission decision. If there are additional iterations of routes, mission data, etc., that additional data can be contained within additional blocks on the blockchain.

In some configurations, the transmitting of the third iteration mission information comprises transmitting only information which changed from the transmitting of the mission profile and the preliminary route.

In some configurations, the autonomous vehicle can be an unmanned aerial vehicle, whereas in other configurations it can be a driverless car, a drone, a robot (such as a warehouse robot). Moreover, if the autonomous vehicle is an unmanned aerial vehicle, a government agency (such as the Federal Aviation Administration in the United States) may be the final approval authority which authorizes drone flights.

In some configurations, the plurality of third parties can include entities such as a weather service, space agencies (such as NASA (National Aeronautics and Space Administration), traffic systems, military branches, shipping yards, train schedules, mass transmit schedules, sporting event schedules, television schedules, etc., to determine what events or activities may be going on in a given location at a given time.

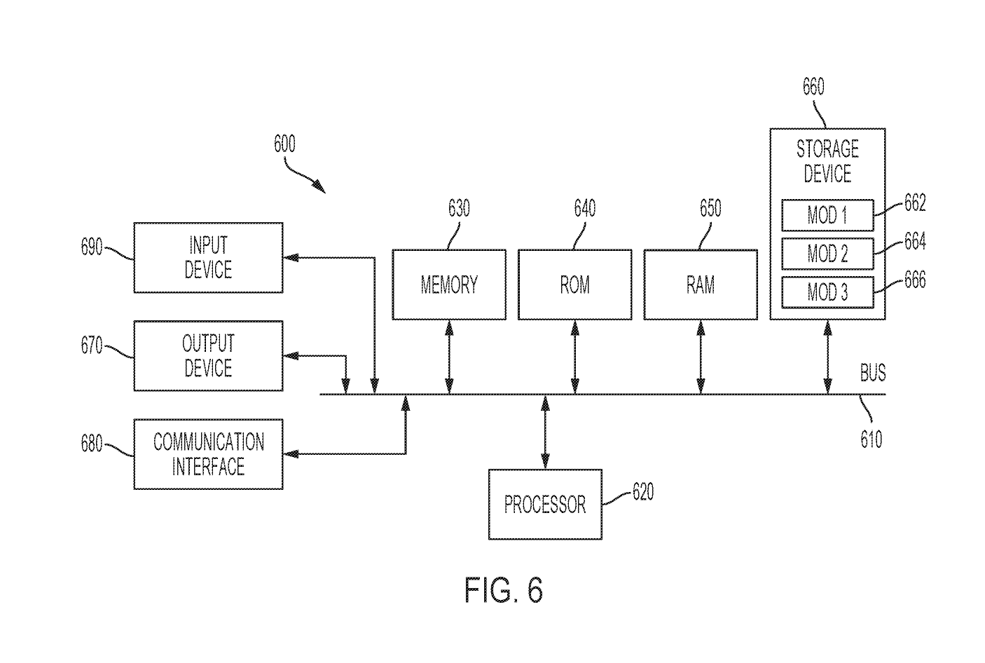

With reference to FIG. 6, an exemplary system includes a general-purpose computing device 600, including a processing unit (CPU or processor) 620 and a system bus 610 that couples various system components including the system memory 630 such as read-only memory (ROM) 640 and random access memory (RAM) 650 to the processor 620. The system 600 can include a cache of high-speed memory connected directly with, in close proximity to, or integrated as part of the processor 620. The system 600 copies data from the memory 630 and/or the storage device 660 to the cache for quick access by the processor 620. In this way, the cache provides a performance boost that avoids processor 620 delays while waiting for data. These and other modules can control or be configured to control the processor 620 to perform various actions. Other system memory 630 may be available for use as well. The memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any general purpose processor and a hardware module or software module, such as module 1 662, module 2 664, and module 3 666 stored in storage device 660, configured to control the processor 620 as well as a special-purpose processor where software instructions are incorporated into the actual processor design. The processor 620 may essentially be a completely self-contained computing system, containing multiple cores or processors, a bus, memory controller, cache, etc. A multi-core processor may be symmetric or asymmetric.

The system bus 610 may be any of several types of bus structures including a memory bus or memory controller, a peripheral bus, and a local bus using any of a variety of bus architectures. A basic input/output (BIOS) stored in ROM 640 or the like, may provide the basic routine that helps to transfer information between elements within the computing device 600, such as during start-up. The computing device 600 further includes storage devices 660 such as a hard disk drive, a magnetic disk drive, an optical disk drive, tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules and other data for the computing device 600. In one aspect, a hardware module that performs a particular function includes the software component stored in a tangible computer-readable storage medium in connection with the necessary hardware components, such as the processor 620, bus 610, display 670, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 600 is a small, handheld computing device, a desktop computer, or a computer server.

Although the exemplary embodiment described herein employs the hard disk 660, other types of computer-readable media which can store data that are accessible by a computer, such as magnetic cassettes, flash memory cards, digital versatile disks, cartridges, random access memories (RAMs) 650, and read-only memory (ROM) 640, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, keyboard, mouse, motion input, speech and so forth. An output device 670 can also be one or more of a number of output mechanisms known to those of skill in the art. In some instances, multimodal systems enable a user to provide multiple types of input to communicate with the computing device 600. The communications interface 680 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving a mission profile for an autonomous vehicle, the mission profile comprising:
a start location;
a second location; and
an action to perform at the second location;
generating a preliminary route between the start location and the second location;
transmitting the mission profile and the preliminary route to a plurality of third parties;
receiving, from each party in the plurality of third parties, a response providing either (1) an approval of the mission profile and the preliminary route or (2) a modification to at least one of the mission profile and the preliminary route, to yield a plurality of preliminary responses;
modifying at least one of the mission profile and preliminary route based on the plurality of preliminary responses, to yield second iteration mission information;
identifying, using current status information of a plurality of autonomous vehicles, a specific autonomous vehicle capable of performing a mission according to the second iteration mission information;
revising the second iteration mission information based on the specific autonomous vehicle, to yield third iteration mission information;
transmitting the third iteration mission information to a final approval authority from the plurality of third parties; and
receiving a mission decision from the final approval authority.

2. The method of claim 1, further comprising:
generating a blockchain using the mission profile, the preliminary route, the plurality of preliminary responses, the second iteration mission information, the third iteration mission information, and the mission decision.

3. The method of claim 2, wherein a copy of the blockchain is stored on the specific autonomous vehicle when travelling between the start location and the second location and while executing the action.

4. The method of claim 2,
wherein a first block of the blockchain comprises:
the mission profile; and
the preliminary route;
wherein a plurality of secondary blocks of the blockchain individually comprise preliminary responses from the plurality of preliminary responses;
wherein a third block comprises the second iteration mission information;
wherein a fourth block comprises the third iteration mission information; and
wherein a fifth block comprises the mission decision.

5. The method of claim 1, wherein the transmitting of the third iteration mission information comprises transmitting only information which changed from the transmitting of the mission profile and the preliminary route.

6. The method of claim 1, wherein the autonomous vehicle is a unmanned aerial vehicle.

7. The method of claim 6, wherein the final approval authority is a government agency with authority to authorize unmanned vehicle flights.

8. The method of claim 1, wherein one party in the plurality of third parties is a weather service.

9. A system comprising:
a processor; and
a computer-readable storage medium having instructions stored which, when executed by the processor, cause the processor to perform operations comprising:
receiving a mission profile for an autonomous vehicle, the mission profile comprising:
a start location;
a second location; and
an action to perform at the second location;
generating a preliminary route between the start location and the second location;
transmitting the mission profile and the preliminary route to a plurality of third parties;
receiving, from each party in the plurality of third parties, a response providing either (1) an approval of the mission profile and the preliminary route or (2) a modification to at least one of the mission profile and the preliminary route, to yield a plurality of preliminary responses;
modifying at least one of the mission profile and preliminary route based on the plurality of preliminary responses, to yield second iteration mission information;
identifying, using current status information of a plurality of autonomous vehicles, a specific autonomous vehicle capable of performing a mission according to the second iteration mission information;
revising the second iteration mission information based on the specific autonomous vehicle, to yield third iteration mission information;
transmitting the third iteration mission information to a final approval authority from the plurality of third parties; and
receiving a mission decision from the final approval authority.

10. The system of claim 9, the computer-readable storage medium having additional instructions stored which, when executed by the processor, cause the processor to perform operations comprising:
generating a blockchain using the mission profile, the preliminary route, the plurality of preliminary responses, the second iteration mission information, the third iteration mission information, and the mission decision.

11. The system of claim 10, wherein a copy of the blockchain is stored on the specific autonomous vehicle when travelling between the start location and the second location and while executing the action.

12. The system of claim 10,
wherein a first block of the blockchain comprises:
the mission profile; and
the preliminary route;
wherein a plurality of secondary blocks of the blockchain individually comprise preliminary responses from the plurality of preliminary responses;
wherein a third block comprises the second iteration mission information;
wherein a fourth block comprises the third iteration mission information; and
wherein a fifth block comprises the mission decision.

13. The system of claim 9, wherein the transmitting of the third iteration mission information comprises transmitting only information which changed from the transmitting of the mission profile and the preliminary route.

14. The system of claim 9, wherein the autonomous vehicle is a unmanned aerial vehicle.

15. The system of claim 14, wherein the final approval authority is a government agency with authority to authorize unmanned vehicle flights.

16. The system of claim 9, wherein one party in the plurality of third parties is a weather service.

17. A non-transitory computer-readable storage device having instructions stored which, when executed by a computing device, cause the computing device to perform operations comprising:
receiving a mission profile for an autonomous vehicle, the mission profile comprising:
a start location;
a second location; and
an action to perform at the second location;
generating a preliminary route between the start location and the second location;
transmitting the mission profile and the preliminary route to a plurality of third parties;
receiving, from each party in the plurality of third parties, a response providing either (1) an approval of the mission profile and the preliminary route or (2) a modification to at least one of the mission profile and the preliminary route, to yield a plurality of preliminary responses;
modifying at least one of the mission profile and preliminary route based on the plurality of preliminary responses, to yield second iteration mission information;
identifying, using current status information of a plurality of autonomous vehicles, a specific autonomous vehicle capable of performing a mission according to the second iteration mission information;
revising the second iteration mission information based on the specific autonomous vehicle, to yield third iteration mission information;
transmitting the third iteration mission information to a final approval authority from the plurality of third parties; and
receiving a mission decision from the final approval authority.

18. The non-transitory computer-readable storage device of claim 17, having additional instructions stored which, when executed by the computing device, cause the computing device to perform operations comprising:
generating a blockchain using the mission profile, the preliminary route, the plurality of preliminary responses, the second iteration mission information, the third iteration mission information, and the mission decision.

19. The non-transitory computer-readable storage device of claim 18, wherein a copy of the blockchain is stored on the specific autonomous vehicle when travelling between the start location and the second location and while executing the action.

20. The non-transitory computer-readable storage device of claim 18,
wherein a first block of the blockchain comprises:
the mission profile; and
the preliminary route;
wherein a plurality of secondary blocks of the blockchain individually comprise preliminary responses from the plurality of preliminary responses;
wherein a third block comprises the second iteration mission information;
wherein a fourth block comprises the third iteration mission information; and
wherein a fifth block comprises the mission decision.
